(19) United States
(12) Patent Application Publication
(10) Pub. No.: US 2026/0322915 A1
(43) Pub. Date: Oct. 15, 2026

(54) METHOD AND SYSTEM FOR DYNAMICALLY SELECTING A VOICE COMMUNICATION CHANNEL FROM A PLURALITY OF VOICE COMMUNICATION CHANNELS DURING AN INTERACTION, IN A CONTACT CENTER BASED ON QUALITY OF SERVICE (QOS) MEASUREMENTS

(71) Applicant: NICE LTD., Ra'anana (IL)

(72) Inventors: Vahid SHAIKH, Pune (IN); Manasi PURKAR, Pune (IN); Basavraj GHULI, Pune (IN)

(21) Appl. No.: 19/179,149

(22) Filed: Apr. 15, 2025

(51) Int. Cl. H04M 3/22; H04M 3/51

(52) U.S. Cl. CPC H04M 3/2227; H04M 3/5133; H04M 3/5175

(57) ABSTRACT

A computerized-method for dynamically selecting a voice communication channel from a plurality of voice communication channels during an interaction, in a contact-center based on QoS measurements. The computerized-method includes for each agent in the contact center that is logged-in to an agent application: (i) receiving a first-voice-communication channel selected by the agent via a UI; (ii) establishing the interaction of the agent via the selected first-voice-communication channel; (iii) continuously monitoring the QoS of the voice communication channel during the interaction of the agent and measuring QoS until the measured QoS is below a quality-threshold; (iv) detecting a second-voice-communication channel in the plurality of communication channels with a measured QoS higher than the first-voice-communication channel and other voice communication channels by operating a learning module; (v) providing the second-voice-communication channel to the agent application; and (vi) configuring the agent application to automatically select in real-time the second-voice-communication channel for the interaction.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever

### TECHNICAL FIELD

The present disclosure relates to the field of dynamically selecting a voice communication channel from a plurality of voice communication channels during an interaction, in a contact center based on Quality of Service (QoS) measurements.

### BACKGROUND

As voice remains a strong channel of choice for high complexity and high emotion customer interactions, voice quality is crucial for customer interactions in contact centers. The voice quality matters to both agent and customer experience. Negative customer experience can lead to higher churn and negative Customer Satisfaction (CSAT) scores. For agents, this could lead to errors, lower morale and higher turnaround time.

Accordingly, there is a need for a technical solution for maintaining a high voice quality that will help turn negative customer experiences into positive ones. There is a need for system and method for dynamically selecting a voice communication channel from a plurality of voice communication channels during an interaction, in a contact center based on Quality of Service (QoS) measurements.

### SUMMARY

There is thus provided, in accordance with some embodiments of the present disclosure, a computerized-method for dynamically selecting a voice communication channel from a plurality of voice communication channels during an interaction, in a contact center based on Quality of Service (QoS) measurements.

In accordance with some embodiments of the present disclosure, the computerized-method may include for each agent in the contact center that is logged-in to an agent application: (i) receiving a first voice communication channel selected by the agent via a User Interface (UI) that is associated to the agent application. The first voice communication channel is selected from the plurality of voice communication channels; (ii) establishing the interaction of the agent via the selected first voice communication channel; (iii) continuously monitoring the QoS of the first voice communication channel during the interaction of the agent and measuring QoS until the measured QoS of the first voice communication channel is below a preconfigured quality-threshold; (iv) detecting a second voice communication channel in the plurality of communication channels with a measured QoS higher than the first voice communication channel and other voice communication channels in the plurality of voice communication channels by operating a learning module; (v) providing the second voice communication channel to the agent application; and (vi) configuring the agent application to automatically select in real-time the second voice communication channel for the interaction.

Furthermore, in accordance with some embodiments of the present disclosure, the voice communication channel is selected by the agent during log-in of the agent through the agent application.

Furthermore, in accordance with some embodiments of the present disclosure, the learning module may include: (i) collecting QoS data of each voice communication channel in the plurality of voice communication channels in real-time during interactions throughout a preconfigured period; (ii) analyzing the collected QoS data to yield an average measured QoS for each voice communication channel. The average measured QoS of each voice communication channel is time-based and season-based; (iii) sorting the plurality of voice communications channels in descending order based on the average measured QoS; (iv) determining the voice communication channel having highest measured QoS as the second voice communication channel.

Furthermore, in accordance with some embodiments of the present disclosure, the QoS data may include at least one metric of: (i) Mean Opinion Score (MOS); (ii) packet loss percentage; (ii) jitter; and (iii) latency.

Furthermore, in accordance with some embodiments of the present disclosure, the analyzing of the collected QoS data may include: (i) operating statistical analysis by computing averages, trends, and deviations to identify overall voice communication channels performance; (ii) detecting patterns by applying Machine Learning (ML), time-series based analysis; and (iii) detecting anomaly to predict when the QoS measurement will be below the preconfigured quality-threshold, based on the detected patterns.

Furthermore, in accordance with some embodiments of the present disclosure, each voice communication channel in the plurality of voice communication channels comprising at least one of: (i) device ID; (ii) device type; (iii) device model; and (iv) device status.

Furthermore, in accordance with some embodiments of the present disclosure, the providing of the second voice communication channel to the agent application may include: (i) receiving an alert to initiate failover; (ii) initiating failover mechanism based on preconfigured failover policy; and (iii) establishing the second voice communication channel by using a protocol that is compatible to the preconfigured failover policy.

Furthermore, in accordance with some embodiments of the present disclosure, the interaction that is established via the first voice communication channel may be conducted via a related network path and using a first codec.

Furthermore, in accordance with some embodiments of the present disclosure, when the measured QoS of the first voice communication channel is below a preconfigured quality-threshold, the computerized-method may further comprise rerouting the interaction via a second network path. The computerized-method may further comprise operating a prediction module to determine the network path and a second codec for the second voice communication channel.

Furthermore, in accordance with some embodiments of the present disclosure, the continuous monitoring of the QoS of the first voice communication channel during the interaction of the agent and the measuring of the measured QoS data may be operated by a Voice Quality Monitoring (VQM) software.

There is further provided, in accordance with some embodiments of the present invention, a computerized-system for dynamically selecting a voice communication channel from a plurality of voice communication channels during an interaction, in a contact center based on Quality of Service (QoS) measurements.

Furthermore, in accordance with some embodiments of the present disclosure, the computerized-system may include a database; a memory to store the database; a User Interface (UI) that is associated to an agent application; and one or more processors.

Furthermore, in accordance with some embodiments of the present disclosure, for each agent in the contact center that is logged-in to the agent application: (i) receive a first voice communication channel selected by the agent via the UI that is associated to the agent application. The first voice communication channel is selected from the plurality of voice communication channels; (ii) establish the interaction of the agent via the selected first voice communication channel; (iii) continuously monitor the QoS of the first voice communication channel during the interaction of the agent and measure QoS until the measured QoS of the first voice communication channel is below a preconfigured quality-threshold; The measured QoS is stored in the database. (iv) detect a second voice communication channel in the plurality of communication channels with a measured QoS higher than the first voice communication channel and other voice communication channels in the plurality of voice communication channels by operating a learning module; (v) provide the second voice communication channel to the agent application; and (vi) configure the agent application to automatically select in real-time the second voice communication channel for the interaction.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a high-level diagram of a computerized-system for dynamically selecting a voice communication channel from a plurality of voice communication channels during an interaction, in a contact center based on Quality of Service (QoS) measurements, in accordance with some embodiments of the present invention;

FIG. 2 schematically illustrates components of a system for dynamically selecting a voice communication channel from a plurality of voice communication channels during an interaction, in a contact center based on QoS measurements, in accordance with some embodiments of the present invention;

FIG. 3 is a visual representation of architecture of a system for dynamically selecting a voice communication channel from a plurality of voice communication channels during an interaction, in a contact center based on QoS measurements, in accordance with some embodiments of the present invention;

FIGS. 4A-4B schematically illustrate a high-level diagram of a computerized-method for dynamically selecting a voice communication channel from a plurality of voice communication channels during an interaction, in a contact center based on Quality of Service (QoS) measurements, in accordance with some embodiments of the present invention;

FIG. 5 schematically illustrates a high-level flowchart of a method for dynamically selecting a voice communication channel from a plurality of voice communication channels during an interaction, in a contact center based on QoS measurements, in accordance with some embodiments of the present invention;

FIG. 6 schematically illustrates a high-level flowchart of predicting voice communication channel with a higher measured QoS, in accordance with some embodiments of the present invention;

FIG. 7 schematically illustrates a high-level flowchart of a learning module, in accordance with some embodiments of the present invention;

FIG. 8 is a graph of QoS, in accordance with some embodiments of the present invention;

FIG. 9 is a screenshot of a User Interface (UI) that is associated to an agent application, in accordance with some embodiments of the present invention;

FIG. 10 is a representation of machine learning QoS performance, in accordance with some embodiments of the present invention;

FIG. 11 schematically illustrates a high-level flowchart of impact of QoS on automatic Call Distributor (ACD) application, in accordance with some embodiments of the present invention;

FIG. 12 schematically illustrates a high-level flowchart of impact of QoS on Workforce Management (WFM) application, in accordance with some embodiments of the present invention;

FIG. 13 schematically illustrates a high-level flowchart of impact of QoS on Quality Management (QM) application, in accordance with some embodiments of the present invention; and

FIG. 14 schematically illustrates a high-level flowchart of impact of QoS on real-time analytics and reporting systems, in accordance with some embodiments of the present invention.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The term “next-best” voice path” as used herein refers to a voice communication channel with a measured QoS higher than the measured voice communication channel that is below a threshold and higher than the measured QoS of all other existing voice communication channels.

Audio quality includes background noise, poor sound clarity, and voice fatigue among agents are issues that lead to misunderstandings, repeated information requests, and longer call handling times, and may negatively impact customer satisfaction and operational efficiency in contact centers.

Remote work of agents in the contact center makes it crucial to focus on the quality of service of the audio. A Voice Quality Monitoring (VQM) software is designed to assess and ensure the quality of voice communication over networks. It uses Quality of Service (QoS) metrics like Mean Opinion Score (MOS), packet loss rate, jitter, and delay to evaluate call quality. VQM tools can help diagnose issues, such as poor audio quality, dropped calls, or network-related problems. The VQM software may monitor SIP voice traffic and agent's WebRTC sessions. It may enable access call data, such as the ISP, location, average bit rate and average round trip time.

The MOS is a rating of voice quality as perceived by users. The packet loss rate is the percentage of data packets lost during transmission. The jitter is variability in packet arrival times. The delay is the time it takes for voice data to travel from sender to receiver. In contact centers for any changes in jitter, MOS, packet loss, the AHT, and call drop values would exponentially rise.

Therefore, there is a need for a technical solution for dynamically selecting a voice communication channel from a plurality of voice communication channels during an interaction, in a contact center based on QoS measurements.

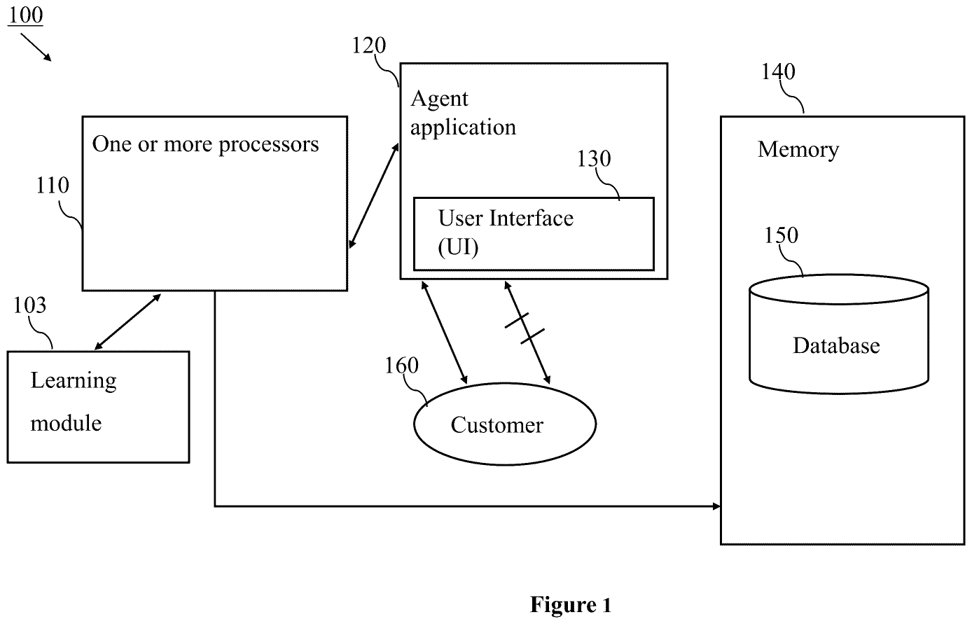

FIG. 1 schematically illustrates a high-level diagram of a computerized-system 100 for dynamically selecting a voice communication channel from a plurality of voice communication channels during an interaction, in a contact center based on Quality of Service (QoS) measurements, in accordance with some embodiments of the present invention.

According to some embodiments of the present disclosure, in a system, such as computerized-system 100, varying conditions and history may affect voice quality in the device of the agent. Poor quality of service may be dynamically switched to next best voice path.

According to some embodiments of the present disclosure, the agent may provide service to call interactions in the contact center from different devices that the agent has chosen during log-in or it may be part of the agent profile. Once the voice path is established between the customer and the agent, if the audio quality lowers beyond acceptable level the customer may not be able to hear the agent properly. This can result in poor experience both for the customer and the agent ultimately affecting the agent's call handling metrics.

According to some embodiments of the present disclosure, current systems do not provide an option for the agent to switch to a better audio device, manually or automatically in real-time without disrupting the ongoing conversation. Computerized-system 100 may detect the degraded audio quality and provide the agent in real-time, an option to the next best alternate option, e.g., voice communication channel.

According to some embodiments of the present disclosure, computerized-system 100 may switch to the next best option, by operating an AI based monitoring engine that will analyze the quality of Service (QoS) of all the ongoing and historic metrics for media across different voice communication channels. Based on the evaluation automatically connect or suggest the best suited voice communication channel for transition.

According to some embodiments of the present disclosure, each voice communication channel in the plurality of voice communication channels may include device ID, device type, device model, and device status.

According to some embodiments of the present disclosure, computerized-system 100 may transparently move the audio stream for the agent to another voice communication channel for a better QoS. A second voice communication channel with a measured QoS higher than the first voice communication channel used in the interaction may be detected. The agent application may be configured to automatically select in real-time the other voice communication channel for the interaction which may result in overall satisfaction, increase in Average Handling Time (AHT) and boosting productivity and reducing customer churn rate.

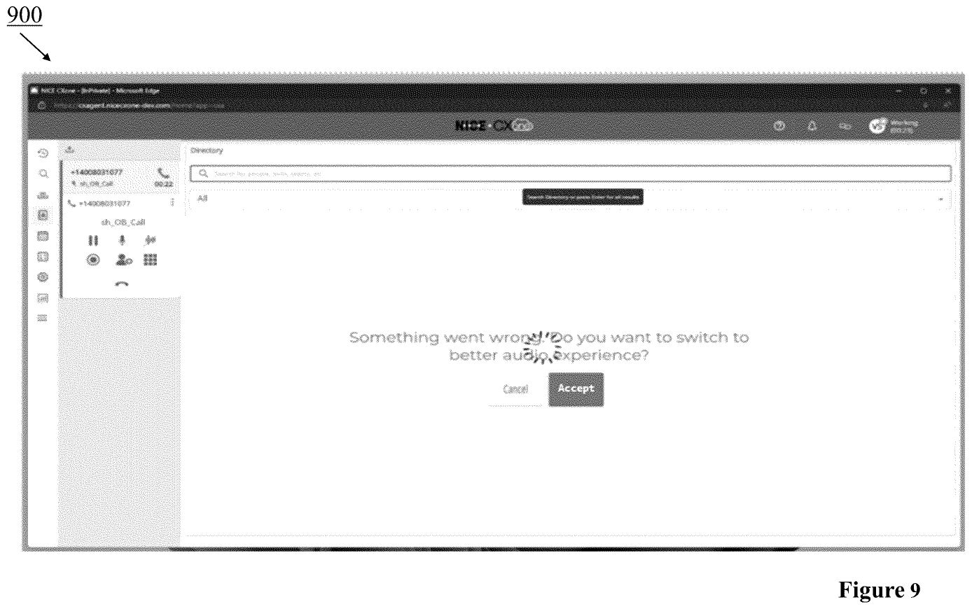

According to some embodiments of the present disclosure, the selection of the other voice communication channel may further improve AHT and call quality metrics. The computerized-system 100 may maintain the AHT and call drop value in a consistent rate despite increased jitter, MOS, and packet loss metrics, due to a change in the voice communication channel when the metrics of the QoS decrease, for example as shown in FIG. 9.

According to some embodiments of the present disclosure, computerized-system 100 may dynamically select in real-time a voice communication channel from a plurality of voice communication channels during an interaction, in a contact center based on QoS measurements.

According to some embodiments of the present disclosure, for each agent in the contact center that is logged-in to an agent application 120 the one or more processors 110 may be configured to receive a voice communication channel selected by the agent via a User Interface (UI) 130 that is associated to the agent application. For example, the voice communication channel may be selected by the agent during log-in of the agent to the agent application 120. Alternatively, the voice communication channel may be configured as a default for each agent from a plurality of voice communication channels.

According to some embodiments of the present disclosure, the one or more processors 110 may establish each interaction of the agent via the selected voice communication channel. The one or more processors 110 may continuously monitor, e.g., by operating an AI engine, the QoS of the audio in the voice communication channel during the interaction of the agent and measure the QoS until the measured QoS of the voice communication channel is below a preconfigured quality-threshold.

According to some embodiments of the present disclosure, the measuring of the QoS may be operated by a Voice Quality Monitoring (VQM) software that is designed to assess and ensure the quality of voice communication over networks. When the measured of the QoS of the voice communication channel may decrease below the preconfigured quality-threshold, the one or more processors 110 may detect another voice communication channel in the plurality of communication channels with a measured QoS higher than the current voice communication channel and other voice communication channels in the plurality of voice communication channels by operating a learning module 103.

According to some embodiments of the present disclosure, the learning module 103 may collect QoS data of each voice communication channel in the plurality of voice communication channels in real-time during interactions throughout a preconfigured period and then analyze the collected QoS data to yield an average measured QoS for each voice communication channel. The QoS data may be raw QoS data points collected from network monitoring tools or log files over the time. The average measured QoS of each voice communication channel may be time-based and season-based. For example, a range of hours throughout the day and a range of weeks or months throughout the year.

According to some embodiments of the present disclosure, the QoS data may include Mean Opinion Score (MOS), packet loss percentage, jitter; and latency. To calculate the measured QoS the following formulas and algorithms may be used. For example, the MOS may be calculated using an E-model formula for Voice over IP (VoIP) such that the MOS equals the function of the packet loss, jitter and latency. The packet loss may be calculated by comparing the number of packets sent vs the number of packets received. The jitter may be derived from time-stamps of consecutive packet arrivals. The latency may be measured by using Round-Trip Time (RTT) or one-way delay measurements.

According to some embodiments of the present disclosure, the analysis of the collected QoS data may include a statistical analysis by computing averages, trends, and deviations to identify overall performance and the detecting patterns by applying Machine Learning (ML), time-series based analysis to detect anomaly to predict when the QoS measurement will be below the preconfigured quality-threshold, based on the detected patterns. The detected pattern may be defined based on history and may be used to predict the time and day of year where QoS may go down.

According to some embodiments of the present disclosure, the prediction of the time and day of year where QoS may go down may be based on many parameters. One of the parameters may be historical data. Once the system may have prediction of possible low QoS, such as on big business days, e.g., Black Friday, Christmas days in call centers, it may enable organizations to take care of it and such that the organization can plan preventive measures in advance. For example, buying or booking additional bandwidth from carrier providers. Hence, when there is any scaling and infrastructure upgrade may be planned ahead of time.

According to some embodiments of the present disclosure, the learning module 103 may sort the plurality of voice communications channels in descending order based on the average measured QoS and then determine the voice communication channel having highest measured QoS as the other voice communication channel that should replace the current voice communication channel.

According to some embodiments of the present disclosure, the one or more processors 110 may provide the determined voice communication channel to the agent application 120. The agent application 120 may be configured to automatically select in real-time the provided voice communication channel for the on-going interaction. The on-going interaction may continue via the provided voice communication channel.

According to some embodiments of the present disclosure, the providing of the other voice communication channel to the agent application 120 may include receiving an alert to initiate failover and then initiating failover mechanism based on preconfigured failover policy. The other voice communication channel with the better QoS may be established by using a protocol that is compatible to the preconfigured failover policy.

According to some embodiments of the present disclosure, computerized-system 100 may monitor and detect QoS issues in voice communication channels, such as packet loss, jitter, latency spikes, or disconnection events. If degradation in the QoS exceeds a predefined threshold, an alert may be triggered to initiate failover mechanism. The failover policy determines whether to switch to a backup network route/channel, like VoIP provider or transport like Publicly Switched Telephone Network (PSTN).

According to some embodiments of the present disclosure, computerized-system 100 may establish a secondary voice communication channel using protocols like Session Initiation Protocol (SIP) re-Invite, Real Time Protocol (RTP) redirection or Web Real-Time Communication (WebRTC) fallback, which is a technology that enables real-time audio, video, and data communication directly between web browsers and devices.

According to some embodiments of the present disclosure, the network rerouting protocol may be for example, Software defined Wide Area Network (SD-WAN) and Dynamic Multiprotocol Label Switching (MPLS).

According to some embodiments of the present disclosure, optionally, when the measured QoS of the current voice communication channel of the on-going interaction is below the preconfigured quality-threshold, the interaction may be rerouted to a different agent when there is no voice communication channel in the plurality of voice communication channels with the measured QoS above the preconfigured quality-threshold.

According to some embodiments of the present disclosure, the interaction that is established via the voice communication channel may be conducted via a related network path and using a specified codec. A prediction module may be operated to determine the network path and another codec for the other voice communication channel with the better QoS. The network path may be predicted based on the trunk selection or service provider. The codec may be upgraded to a wideband which provides a higher QoS with lower bandwidth.

According to some embodiments of the present disclosure, the higher QoS or audio clarity may be a relative term. For example: G.711 has better audio quality, which comes at a cost of bandwidth, whereas G.729 is cheaper on bandwidth but relatively lower audio quality. For example, the G.711 may be used when a high-bandwidth network is implemented such as Local Area Network (LAN) or private Multiprotocol Label Switching (MPLS), the best voice quality is wanted and avoiding transcoding and maintaining low latency.

According to some embodiments of the present disclosure, the G.729 may be used when there is a bandwidth-constrained connection, handling mobile or remote calls and there is a need to support more concurrent calls on a limited infrastructure.

According to some embodiments of the present disclosure, the VQM may be continuously collecting the metrics of the underlying voice network including the performance of the network paths and current codecs set, then its learning module's job to use this data along with historical metrics to come up with predictions using machine learning algorithms on the mentioned available metrics.

According to some embodiments of the present disclosure, an efficient codec and a robust protocol work together to ensure high QoS parameters like Mean Opinion Score (MOS), to enhance the user experience. A well-optimized codec compresses and decompresses audio with minimal loss, ensuring high-quality voice transmission while keeping bandwidth usage low. Codecs like Opus or G.722 adapt dynamically to network conditions, balancing quality and efficiency.

According to some embodiments of the present disclosure, a robust protocol, such as SIP, RTP, and SRTP ensure reliable and secure transmission. RTP manages real-time data delivery, while error correction mechanisms, e.g., Forward Error Correction, jitter buffers, mitigate packet loss and latency. Together, an efficient codec minimizes bandwidth requirements while maintaining clarity, and a robust protocol ensures smooth, uninterrupted delivery. This synergy keeps MOS high, leading to a superior user experience in VoIP and real-time communication systems.

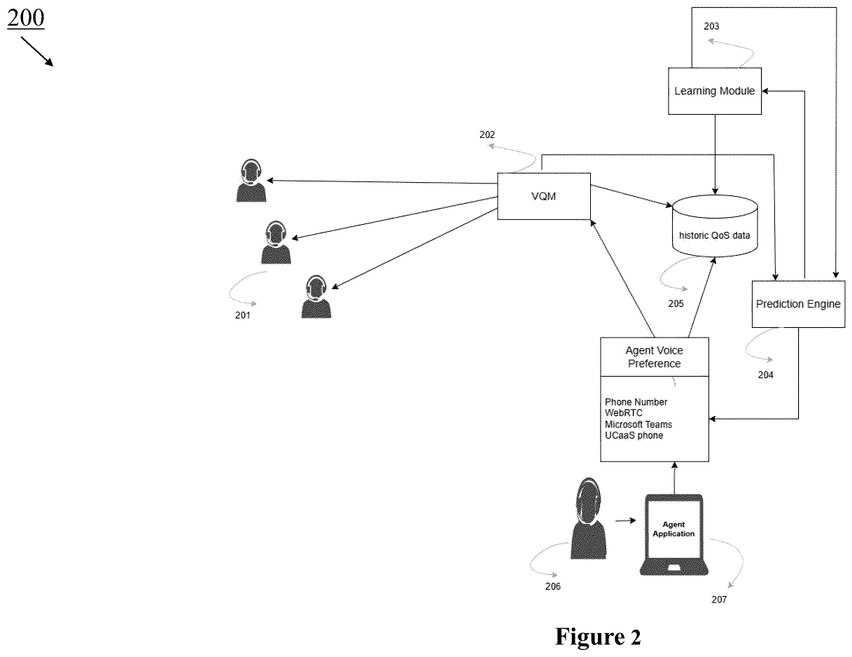

FIG. 2 schematically illustrates components of a system 200 for dynamically selecting a voice communication channel from a plurality of voice communication channels during an interaction, in a contact center based on QoS measurements, in accordance with some embodiments of the present invention.

According to some embodiments of the present disclosure, a system, such as system 200 may have similar components as computerized-system 100 in FIG. 1.

According to some embodiments of the present disclosure, agents 201 working in a contact center whose current and historical QoS data is being monitored and detected by a system, such as computerized-system 100 in FIG. 1. The Voice Quality Manager (VQM) software 202 may operate a Voice QoS monitoring service which may be implemented as a microservice. It collects the voice metrics from agents and underlying platforms e.g., media gateways and media managers.

According to some embodiments of the present disclosure, the learning module 203, such as learning module 103 in FIG. 1 may be implemented as a microservice. The learning module 203 may calculate and devise the next-best alternate voice communication channel option for an impacted agent having measured QoS below a preconfigured threshold. By using historical data of the voice communication channels'performance, it may provide the most suitable alternate voice communication channel for the agent. The learning module 203 may continuously measure and calculate the next-best voice communication channel for the agent. The data may be sent over to the prediction engine 204.

According to some embodiments of the present disclosure, the prediction engine 204 may be implemented as a microservice which receives the QoS degradation notification from the VQM 202. The prediction engine 204 may send the request to learning module 203 for fetching the best preferred voice communication channel for the impacted agent.

According to some embodiments of the present disclosure, once it receives the response from the learning module 203 the prediction module 204 may present the option to the impacted agent for a smooth switch over to new voice channel.

According to some embodiments of the present disclosure, the historical data of the QoS may be stored in a database, such as historic QoS data database 205 by the VQM software 202. It typically contains the historical information about the voice channel's performance metrics. The learning module 203 may use this information for the algorithm to calculate or find the best voice channel for an agent, which has experienced the low voice communication channel QoS.

According to some embodiments of the present disclosure, an agent, such as agent 206 may conduct an interaction via a voice communication channel via the agent application 207. Once the QoS goes below the preconfigured threshold the voice communication channel may be adjusted to the next-best voice communication channel.

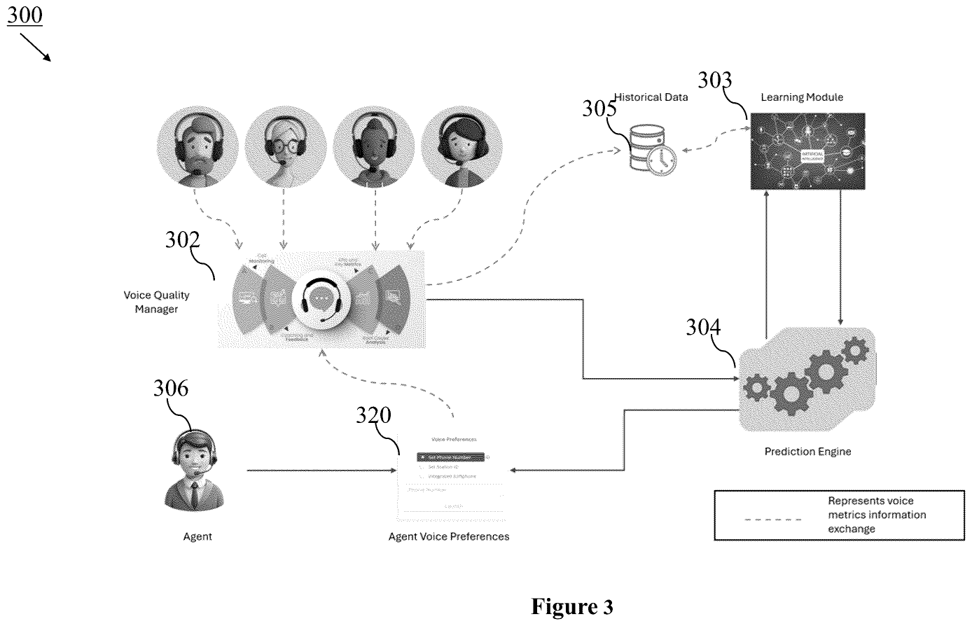

FIG. 3 is a visual representation of architecture of a system 300 for dynamically selecting a voice communication channel from a plurality of voice communication channels during an interaction, in a contact center based on QoS measurements, in accordance with some embodiments of the present invention.

According to some embodiments of the present disclosure, in a computerized-system, such as computerized-system 100 in FIG. 1, the agent 306 may login with a preferred voice communication channel. The preferred voice communication channel may be selected from a UI 320 that may be associated to an agent application.

According to some embodiments of the present disclosure, the Voice Quality Manager (VQM) 302, such as VQM software 202 in FIG. 2, may provide a monitoring service which may be implemented as a microservice. The VQM software 302 may collect the voice metrics from agents and underlying platforms, e.g., from media gateways and media managers. The QM may send the collected voice metrics to a database, such as historical database 305 and such as historic QoS data database 205 in FIG. 2.

According to some embodiments of the present disclosure, the VQM 302 software may notify as to low QoS on currently preferred voice communication channel to the prediction engine 304.

According to some embodiments of the present disclosure, the prediction engine 304, such as prediction engine 204 in FIG. 2 may be implemented as a microservice which receives the QoS degradation notification from the VQM software 302. Then, it sends the request to the learning module 303 for getting alternate best preferred voice communication channel for the impacted agent 306. Once it receives the response from the learning module 303 the prediction engine 304 may present the option to the impacted agent for a smooth switch over to a new voice communication channel.

According to some embodiments of the present disclosure, the learning module 303 may be implemented as a microservice which is the core of calculating and devising the best alternate voice channel option for an impacted agent. The learning module may process the request and respond with an alternative voice communication channel. It has the AI integrated with it and using the historical data of the voice communication channels performance it provides the most suitable alternate voice communication channel for the impacted agent 306. This calculated alternate voice channel is then responded to the request from prediction engine 304.

According to some embodiments of the present disclosure, the historical data database 305 may be populated by the VQM software 302. It may contain the historical voice channels performance metrics. The learning module 303 may use the information for its algorithm to detect the best voice communication channel for an agent, which has experienced the low voice communication channel QoS.

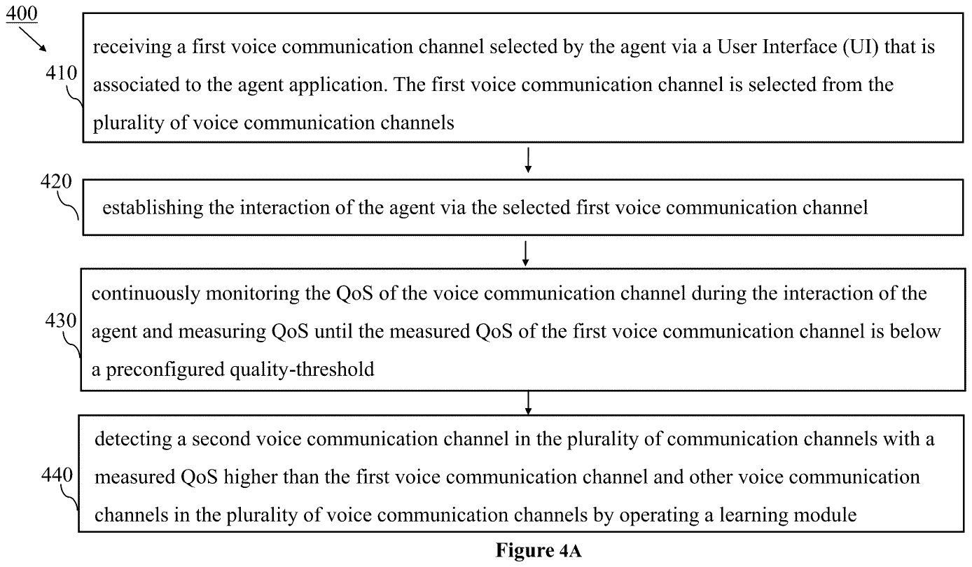

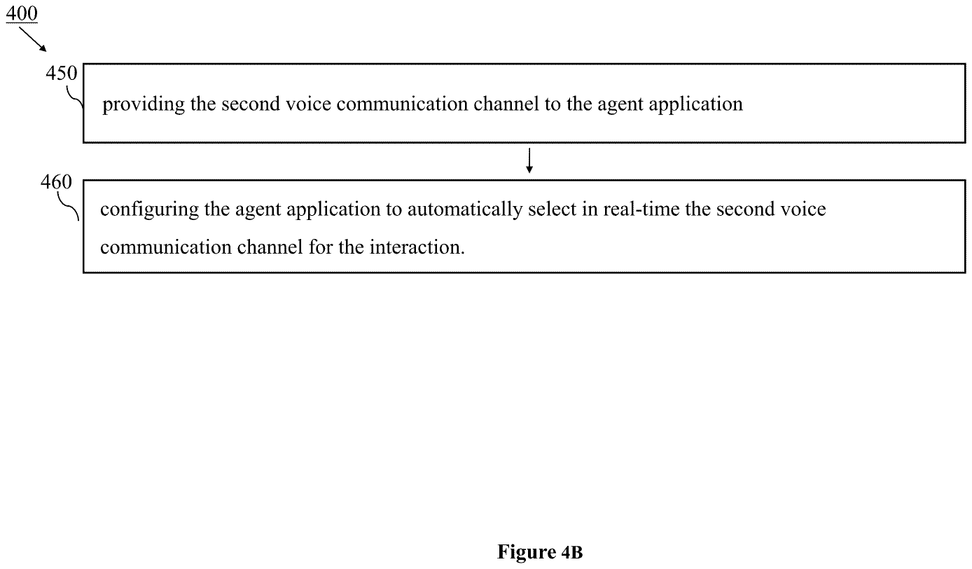

FIGS. 4A-4B schematically illustrate a high-level flowchart 400 of a computerized-method for dynamically selecting a voice communication channel from a plurality of voice communication channels during an interaction, in a contact center based on Quality of Service (QoS) measurements, in accordance with some embodiments of the present invention.

According to some embodiments of the present disclosure, operation 410 comprising receiving a first voice communication channel selected by the agent via a User Interface (UI) that is associated to the agent application. The first voice communication channel is selected from the plurality of voice communication channels.

According to some embodiments of the present disclosure, operation 420 comprising establishing the interaction of the agent via the selected first voice communication channel.

According to some embodiments of the present disclosure, operation 430 comprising continuously monitoring the QoS of the voice communication channel during the interaction of the agent and measuring QoS until the measured QoS of the first voice communication channel is below a preconfigured quality-threshold.

According to some embodiments of the present disclosure, operation 440 comprising detecting a second voice communication channel in the plurality of communication channels with a measured QoS higher than the first voice communication channel and other voice communication channels in the plurality of voice communication channels by operating a learning module.

According to some embodiments of the present disclosure, operation 450 comprising providing the second voice communication channel to the agent application.

According to some embodiments of the present disclosure, operation 460 comprising configuring the agent application to automatically select in real-time the second voice communication channel for the interaction.

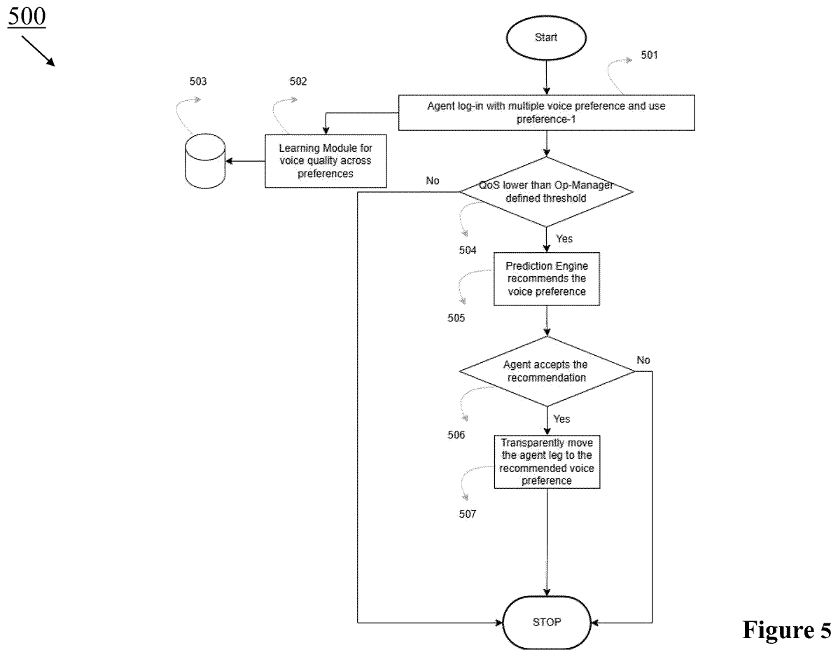

FIG. 5 schematically illustrates a high-level flowchart 500 of a method for dynamically selecting a voice communication channel from a plurality of voice communication channels during an interaction, in a contact center based on QoS measurements, in accordance with some embodiments of the present invention.

According to some embodiments of the present disclosure, in a system, such as system 100 in FIG. 1, and such as system 200 in FIG. 2 the agent may be in a log-in state with multiple voice preference and use one of them as the voice communication channel to conduct interactions 501 via the agent application.

According to some embodiments of the present disclosure, a module, such as learning module 103 in FIG. 1 may check the voice quality across preferences 502, which are the available voice communication channels. The learning module may continuously refer to QoS historical table 503, such as database 150 in FIG. 1, and such as historic QoS data 205 in FIG. 2 to determine the next-best voice communication channel option.

According to some embodiments of the present disclosure, evaluating if the current QoS score is lower than Op-manager defined threshold 504 which is the QoS score that is defined by the Operations Manager as the required threshold for a stable voice leg connection, e.g., measured QoS in the current voice communication channel.

According to some embodiments of the present disclosure, if the evaluated current QoS is lower than the predefined threshold then a module, such as prediction engine may recommend the voice preference 505, which is the next-best voice communication channel.

According to some embodiments of the present disclosure, when the agent accepts the recommended next-best voice communication channel 506, then the system may transparently move the agent leg to the next-best voice preference leg 507, which is continuing the on-going interaction via the recommended voice communication channel.

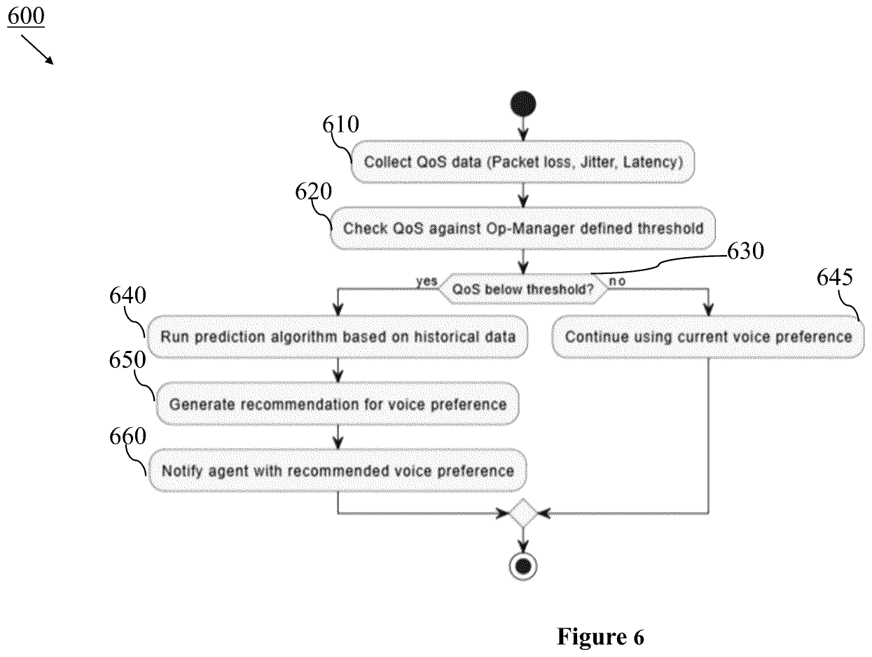

FIG. 6 schematically illustrates a high-level flowchart 600 of predicting voice communication channel with a higher measured QoS, in accordance with some embodiments of the present invention.

According to some embodiments of the present disclosure, in a system such as computerized-system 200 in FIG. 2 QoS data may be collected, such as packet loss, jitter and latency 610. For example, the learning module may use the QoS provided by the VQM to calculate next best alternate voice channel.

According to some embodiments of the present disclosure, the QoS data may be checked against Op-manager defined threshold 620, by comparing the collected QoS data to a predefined threshold e.g., by an operation manager.

According to some embodiments of the present disclosure, checking if the QoS data is below threshold 630, and when the QoS data is below the threshold the prediction module may be operated by running prediction algorithm based on historical data 640. Otherwise, continue using the current voice preference 645.

According to some embodiments of the present disclosure, the prediction module may generate a recommendation for voice preference 650 and inform the agent of the recommended voice preference, e.g., the voice communication channel with next-best QoS data 660. The next-best voice communication channel may be automatically connected to the agent application for the on-going interaction.

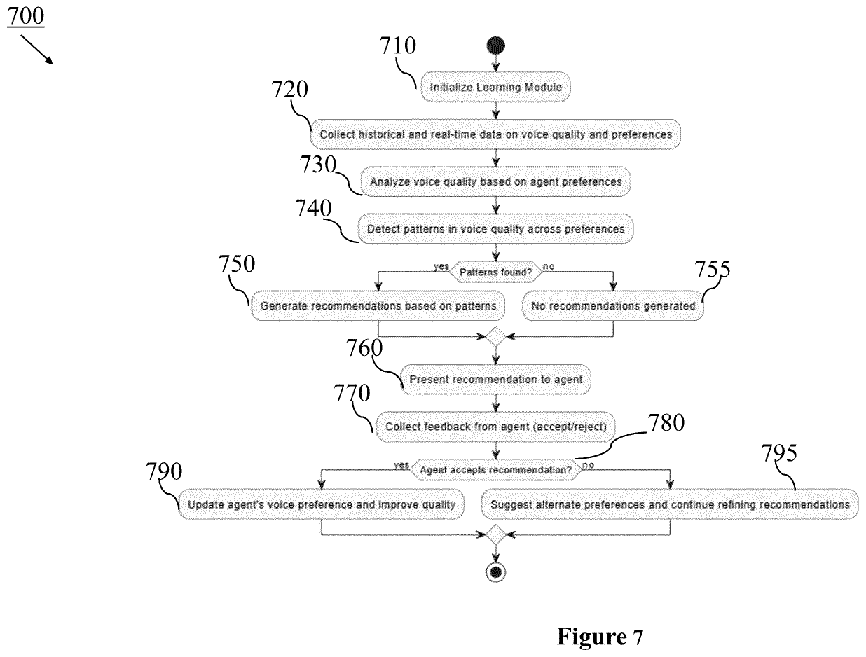

FIG. 7 schematically illustrates a high-level flowchart 700 of a learning module, in accordance with some embodiments of the present invention.

According to some embodiments of the present disclosure, in a system, such as computerized-system 100 in FIG. 1, the learning module may be initialized 710 to be prepared to process QoS data.

According to some embodiments of the present disclosure, the learning module may collect QoS historical and real-time data on voice quality preferences 720. This data may be used to understand how different voice preferences impact performance.

According to some embodiments of the present disclosure, the voice quality may be analyzed based on agent preferences 730. The collected data is analyzed to understand how voice quality varies with different agent devices and voice channel preferences.

According to some embodiments of the present disclosure, patterns in the data may be detected as the learning module detects patterns in voice quality across preferences 740, such as particular preferences leading to better or worse call quality. This can involve statistical analysis or machine learning techniques.

According to some embodiments of the present disclosure, when patterns have been detected in the QoS data the learning module generates recommendations based on the patterns 750 and otherwise, the learning modules may not generate recommendations 755. The recommendations may be generated for voice preferences that would likely improve call quality.

According to some embodiments of the present disclosure, the recommendations may be presented to the agent 760 and feedback may be collected from the agent 770, e.g., accept or reject. The agent either accepts or rejects the recommendation. The system collects this feedback to refine future recommendations.

According to some embodiments of the present disclosure, checking if the agent accepted the recommendation 780 and if the agent accepts the recommendation the system may update the agent's voice preference to improve future call quality 790.

According to some embodiments of the present disclosure, if the agent rejects the recommendation, the system suggests alternative preferences and continues to refine the recommendation logic 795.

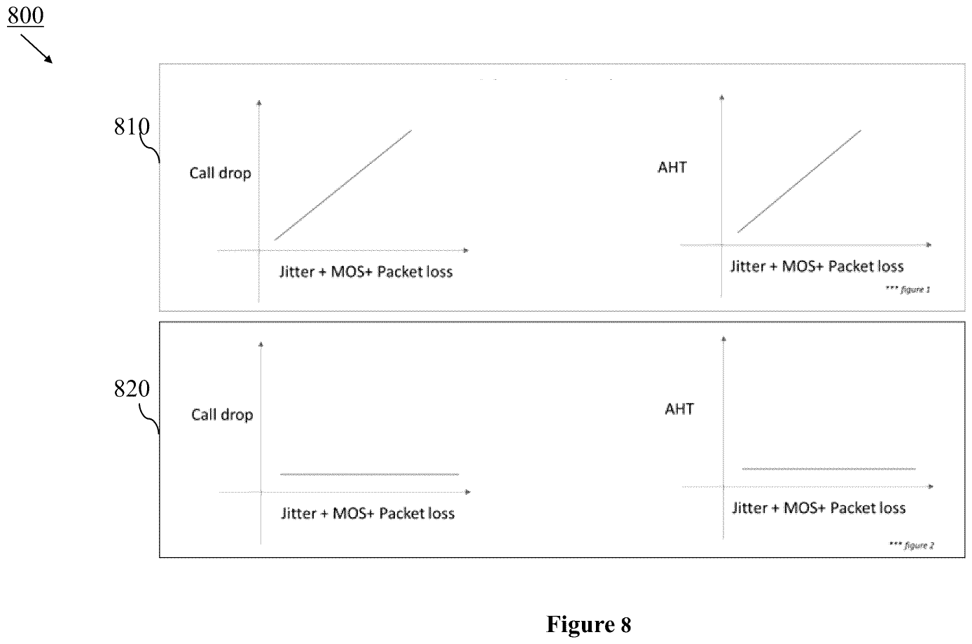

FIG. 8 is a graph of QoS, in accordance with some embodiments of the present invention.

According to some embodiments of the present disclosure, before using a system, such as computerized-system 100 in FIG. 1, there was an increase in call drop and AHT when the QoS metrics increased, as shown in graphs 810.

According to some embodiments of the present disclosure, after the implementation of a system, such as computerized-system 100 in FIG. 1, the level of call drop and AHT remains low due to the voice communication channel change when these metrics decrease, thus in overall the jitter, MOS and packet loss may not increase during the interactions in the contact center.

FIG. 9 is a screenshot of a User Interface (UI) 9 that is associated to an agent application, in accordance with some embodiments of the present invention

According to some embodiments of the present disclosure, in a system, such as computerized-system 100 in FIG. 1, and such as system 200 in FIG. 2, UI 900 represents a situation where the agent device has been connected, and the agent was on call. During this call the monitoring service VQM detects the low QoS on this agent leg connectivity. Accordingly, the VQM software notifies the low QoS to the prediction engine, such as prediction module 204 in system 200 in FIG. 2.

According to some embodiments of the present disclosure, the prediction engine requests the learning module, such as learning module 103 in FIG. 1 and such as learning module 203 in FIG. 2, for alternate better agent leg connectivity option for this impacted agent. On receiving the response with alternate better agent leg connectivity option, the prediction engine may present that option to the agent, as “accept” or “cancel”. Once the agent accepts the switch over then the back end smoothly moves the currently connected agent leg to newly chosen option of connectivity.

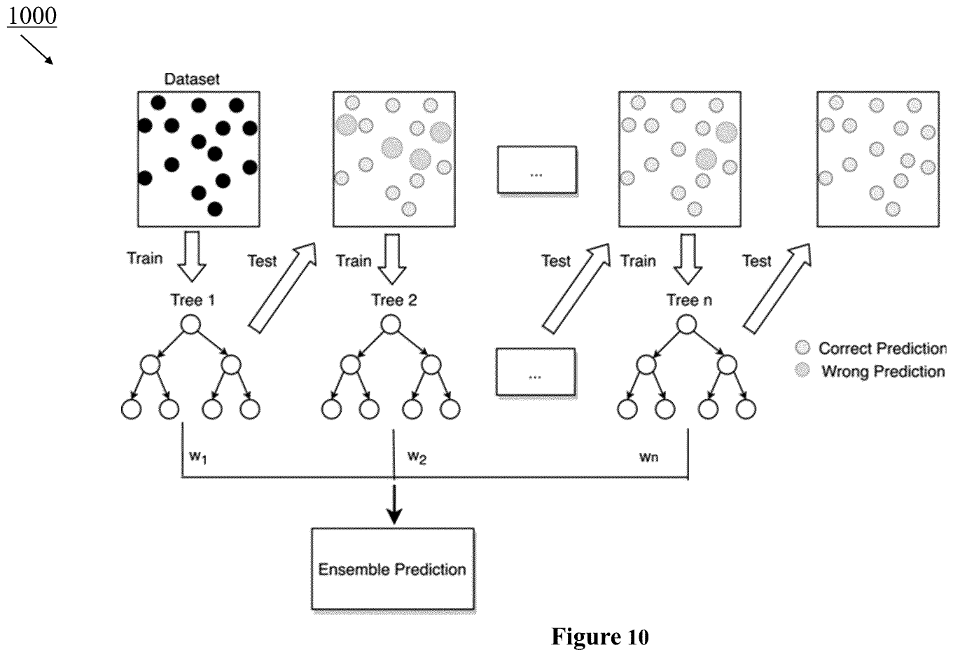

FIG. 10 is a representation of machine learning QoS performance 1000, in accordance with some embodiments of the present invention.

According to some embodiments of the present disclosure, a graphical representation of the QoS performance across different times of the day and busy call center days like New Year, Black Friday, Christmas, Boxing Day, and Cyber Monday.

According to some embodiments of the present disclosure, a Gradient Boosting Model, such as XGBoost, LightGBM, or CatBoost, may be implemented to measure QoS data and QoS performance.

According to some embodiments of the present disclosure, the Gradient Boosting Model (GBM) handles non-linear relationships between the input features and QoS. They are robust against overfitting if tuned properly and they automatically learn which factors, such as time of day, season, or special days, have the biggest impact on the QoS data. Also, they handle missing data effectively.

According to some embodiments of the present disclosure, the QoS measurement, e.g., QoS Score can be modeled as a regression problem e.g., predicting QoS or a classification problem, e.g., predicting the best option.

According to some embodiments of the present disclosure, feature engineering may be implemented to convert categorical data, such as morning time or Christmas holiday into a format usable by GBM. One-hit encoding may convert categories into binary columns. Label encoding may convert categories into numeric labels.

According to some embodiments of the present disclosure, for example, the transformation of time of day “morning” and special day “regular day” may be encoded features [0,0,0,1,0,0]. In another example, the transformation of time of day “afternoon” and special day “Black Friday” may be encoded features [1,0,0,0,1,0]. In yest another example, time of day “night” and special day “Christmas” may be feature encoded [0,1,0,0,0,1].

According to some embodiments of the present disclosure, the representation of machine learning QoS performance 1000 shows an ensemble learning technique, like Boosting, e.g., AdaBoost, which combines multiple decision trees to improve predictive accuracy.

According to some embodiments of the present disclosure, the dataset may be divided into training and testing subsets multiple times. The size and distribution of samples change in subsequent iterations, suggesting weighed training data.

According to some embodiments of the present disclosure, as to the decision trees, each tree, Tree 1, Tree 2, . . . , Tree n is trained on different weighted subsets of the dataset. The arrows labeled “Train” indicate model training, while “Test” arrows indicate evaluation.

According to some embodiments of the present disclosure, the prediction evaluations is shown in the shaded circles. Light gray circles represent correct predictions by the trees. Darker gray circles represent incorrect predictions, showing that mistakes from earlier trees influence later tree training.

According to some embodiments of the present disclosure, the weighting of trees is to enable each tree to contribute its weight to the final prediction. More accurate trees have higher influence.

According to some embodiments of the present disclosure, the final ensemble prediction may be calculated by the combination of the weighted trees. This structure indicates an iterative learning process where errors from previous models help improve subsequent models, aligning with Boosting methods like AdaBoost or Gradient Boosting.

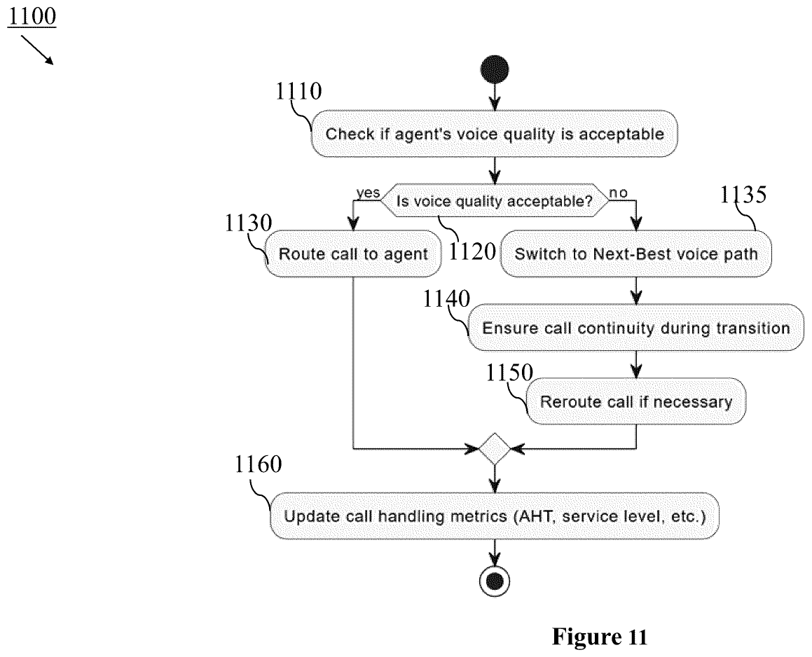

FIG. 11 schematically illustrates a high-level flowchart 1100 of impact of QoS on Automatic Call Distributor (ACD) application, in accordance with some embodiments of the present invention.

According to some embodiments of the present disclosure, the measured QoS of computerized-system 100 in FIG. 1 may be used in an ACD application. The dynamic voice communication channel selection, in a system, such as computerized-system 100 in FIG. 1, which automatically detects and switches to a “Next-Best” voice path, may positively impact on other call center systems such as the ACD application.

According to some embodiments of the present disclosure, the ACD is responsible for routing incoming calls to agents based on predefined rules, which may include the agent's skills, availability, and level of expertise. Introducing a dynamic voice channel selection system positively impacts the ACD in different ways.

According to some embodiments of the present disclosure, the ACD application may route the calls based on the agent's availability, skills, and workload and may consider the device or voice channel an agent is currently on. If the agent's current voice quality degrades, the system could trigger a rerouting process, not just for the call but also ensuring the best quality voice path.

According to some embodiments of the present disclosure, when an agent's voice quality drops below an acceptable level, and they are switched to a Next-Best voice path, the ACD application should ensure that the call continues seamlessly during the transition.

According to some embodiments of the present disclosure, the ACD might need to adapt to handle the situations where the calls are temporarily put on hold for voice path adjustment or rerouted to different agents when required. This could affect the average waiting times, service levels, and call abandonment rates, requiring updates to ACD's performance tracking capabilities.

According to some embodiments of the present disclosure, the operation of the ACD may begin when an incoming call is directed to an agent, or during the routing process if the call is already in progress.

According to some embodiments of the present disclosure, the ACD may check if the agent's voice quality is acceptable 1110, e.g., above a predefined threshold, during the call. This could be determined based on various factors like network latency, audio clarity, volume issues, or any signal disturbances.

According to some embodiments of the present disclosure, tools like voice analysis software, e.g., VQM software, call quality metrics, or network monitoring could be used to assess whether the call's quality meets a predefined acceptable threshold.

According to some embodiments of the present disclosure, if voice quality is acceptable 1120 then the ACD application may route the call to the agent 1130, and otherwise the ACD may switch to next-best voice path 1135. This may include routing the call through another communication method or changing the network path to ensure the call remains clear. For example, switching from an ethernet to a wi-fi connection. In another example, changing the agent's call channel from PSTN trunk to a VoIP system or vice versa.

According to some embodiments of the present disclosure, the ACD application may ensure the call continuity during transition 1140 and reroute the call if necessary 1150, e.g., when the voice quality goes below the predefined threshold. The primary goal here is to improve call quality by routing it through a more reliable voice channel. If the initial attempt to switch to the next-best voice path doesn't resolve the voice quality issue, the ACD application may attempt to reroute the call.

According to some embodiments of the present disclosure, the call may be tracked for call handling metrics like Average Handle Time (AHT), service level adherence, etc.

According to some embodiments of the present disclosure, the rerouting of the call may include switching the call to another agent if the current one has a persistent issue, escalating the call to a higher-quality communication line and using a different technology or network connection, e.g., rerouting from a voice call to a chat or video call if voice is unreliable.

According to some embodiments of the present disclosure, the ACD application may ensure call continuity during the voice communication channel transition while switching to the next-best voice path. A failover mechanism may be used, call handoffs, or network rerouting protocols that ensure the call remains uninterrupted while the system transitions to the better path.

According to some embodiments of the present disclosure, the ACD application may ensure that the call quality remains acceptable, so the customer doesn't experience poor service or abandon the call.

According to some embodiments of the present disclosure, whether the call was routed to the agent successfully, switched to a better path, or rerouted, the system, such as computerized-system 100 in FIG. 1 may update call handling metrics. Average Handle Time (AHT) is a metric that tracks the average time an agent spends handling calls. If the call had to be rerouted or switched to a new path, this might increase AHT. Service Level metric measures whether the Service Level Agreement (SLA) for call answer times is being met. If call routing is delayed or rerouted, it could affect this metric. The performance data may be collected for reporting or further analysis to optimize system behavior or improve agent workflows.

According to some embodiments of the present disclosure, after the metrics are updated, the call handling process concludes, and the system awaits the next call or request.

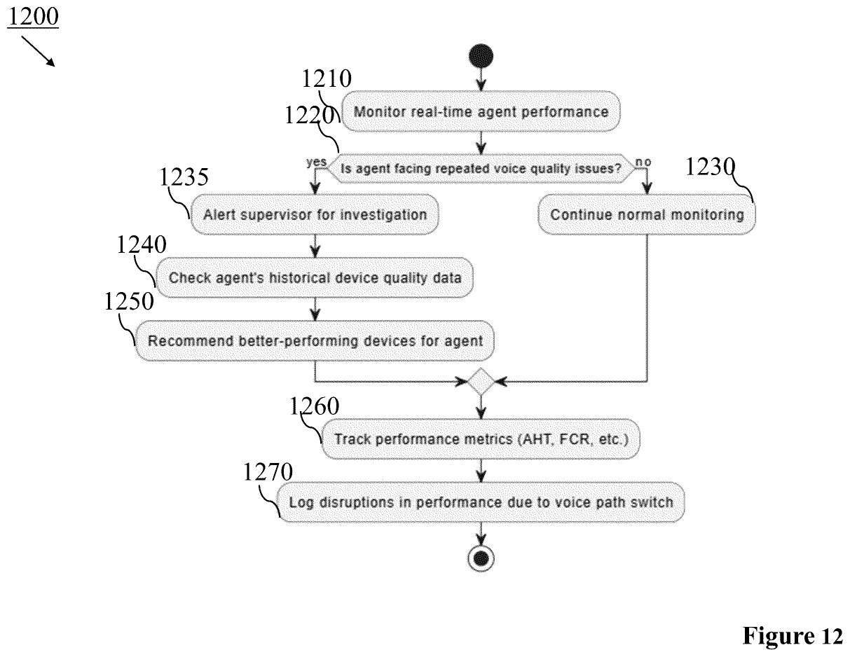

FIG. 12 schematically illustrates a high-level flowchart 1200 of impact of QoS on Workforce Management (WFM) application, in accordance with some embodiments of the present invention.

According to some embodiments of the present disclosure, the measured QoS of computerized-system 100 in FIG. 1 may be used in a WFM application. The dynamic voice channel selection system, which automatically detects and switches to a “Next-Best” voice path, may impact a WFM application.

According to some embodiments of the present disclosure, the WFM application commonly tracks the agents'productivity, schedule adherence, and call handling performance.

According to some embodiments of the present disclosure, the WFM application monitors real-time agent status and performance. With the new dynamic voice path selection, the WFM application may need to be integrated with the voice quality monitoring engine. Alerts can be generated for supervisors if agents are repeatedly facing voice quality issues, which may indicate hardware, infrastructure, networking or VoIP trunk issues that need attention.

According to some embodiments of the present disclosure, the WFM application might need to accommodate changes in agent profiles, specifically regarding device preferences. For instance, an agent who consistently faces poor voice quality on a particular device could be recommended or scheduled to use better-performing devices, based on historical voice quality data.

According to some embodiments of the present disclosure, the switch to a better voice path may improve or stabilize an agent's performance metrics. If a switch is made due to a poor-quality path, WFM systems may log this as a disruption, potentially affecting the metrics like Average Handle Time (AHT), First Call Resolution (FCR), and customer satisfaction scores. This could be used as a point of analysis for identifying trends in agent performance tied to voice quality.

According to some embodiments of the present disclosure, the WFM application may monitor real-time agent performance 1210. Continuously collecting QoS data on various performance metrics that are critical to measuring agent effectiveness. For example, Average Handle Time (AHT), which is the average time taken by an agent to resolve a customer issue. In another example, First Call Resolution (FCR) which is the percentage of calls that are resolved in the first interaction, without needing follow-up. In yet another example, Customer Satisfaction (CSAT), which is a measure of how satisfied customers are with the agent's performance. In yet another example, Voice Quality Metrics (VQM) includes factors like latency, jitter, packet loss, and other elements that affect call quality.

According to some embodiments of the present disclosure, checking if the agent is facing repeated voice quality issues 1220 and if so, an alert may be sent to the supervisor for investigation 1235. Otherwise, continue normal monitoring 1230. This check focuses specifically on whether the agent is encountering problems related to the voice path, which may include issues such as: poor call quality, e.g., echo, distortion, or dropouts, high latency or jitter and connection drops. If the agent is experiencing repeated voice quality issues, the process takes a different path, triggering further actions.

According to some embodiments of the present disclosure, if voice quality issues are detected, the system alerts the supervisor to investigate the issue 1235. This may involve notifying the supervisor via a real-time dashboard or triggering an automated notification, such as an email or in-app message. Then, checking agent's historical device quality data 1240. This involves pulling up the agent's past performance logs related to their devices, e.g., headphones, microphones, computers, voice channel etc. and analyzing past voice quality issues with their current setup and any patterns or trends that might suggest the issue lies with the agent's device.

According to some embodiments of the present disclosure, based on the historical data analysis, recommend specific better-performing devices for the agent 1250. These devices could be suggested based on the agent's historical issues with their current hardware, devices that have been shown to provide better performance in similar environments, compatibility with the agent's work environment, such as noise cancellation or improved bandwidth capabilities, alternat voice channel etc.

According to some embodiments of the present disclosure, if the agent is not facing repeated voice quality issues, the algorithm simply continues with normal monitoring. This means no further actions are needed at that moment. The algorithm continues tracking the performance metrics, ensuring that the agent's work is continuously observed for any other performance disruptions.

According to some embodiments of the present disclosure, track performance metrics, such as AHT, FCR, and the like. Regardless of whether voice quality issues are detected, continue to track performance metrics throughout the agent's shift.

According to some embodiments of the present disclosure, the real-time monitoring and tracking will continue throughout the agent's shift. Log disruption in performance due to voice path switch 1270.

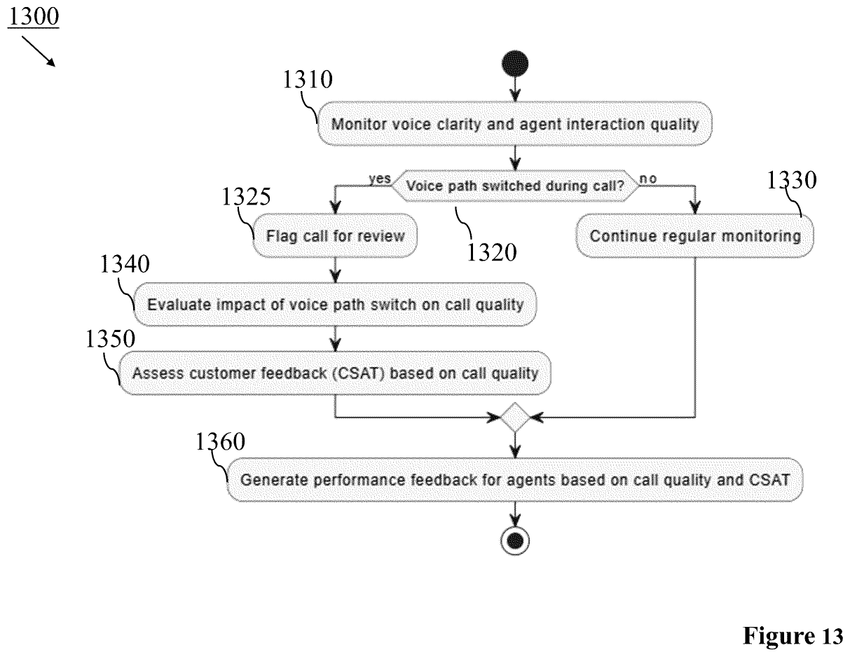

FIG. 13 schematically illustrates a high-level flowchart 1300 of impact of QoS on Quality Management (QM) application, in accordance with some embodiments of the present invention.

According to some embodiments of the present disclosure, a system, such as system 100 in FIG. 1, which automatically detects and switches to a “next-Best” voice path, may impact a QM application.

According to some embodiments of the present disclosure, QM systems typically evaluate and score agent interactions, different aspects, such as customer experience, agent demeanor, call handling efficiency, and adherence to the protocols or guidelines paid down by the process.

According to some embodiments of the present disclosure, the dynamic voice channel selection of computerized-system 100 in FIG. 1 may affect the call quality monitoring of the QM application. QM applications rely on assessing voice clarity and customer-agent interaction quality. When the AI engine switches to a Next-Best voice path, it could improve or degrade the perception of the call quality. This switch would require QM applications to dynamically adjust their analysis of call quality. For instance, an agent's performance may be evaluated differently depending on whether the call was impacted by poor voice quality.

According to some embodiments of the present disclosure, the dynamic voice channel selection of computerized-system 100 in FIG. 1 may automate the flagging of interactions for review of the QM application. Calls where the QM application may detect a switch to a different voice channel due to degraded quality may be flagged for review by the QM application. The flagging of such calls may enable quality analysts to examine the reason for the switch and ensure that it didn't negatively impact on the customer experience. Such flags could lead to more granular performance assessments and actionable feedback.

According to some embodiments of the present disclosure, the dynamic voice channel selection of computerized-system 100 in FIG. 1 may further affect the CSAT of the QM application. As voice quality directly impacts customer satisfaction, if a voice path is switched mid-call, it could be noted in the QM system. The system may relate the impact of voice degradation and subsequent correction with customer feedback, adjusting the CSAT scores accordingly.

According to some embodiments of the present disclosure, the process may begin with monitoring the voice clarity and agent interaction quality 1310. The real-time monitoring tools may operate to assess the quality of the call, the clarity of voice, and the effectiveness of the interaction between the agent and the customer.

According to some embodiments of the present disclosure, for each call, the QM application may check if the voice path, e.g., from VoIP to PSTN, or from one device to other switched during the call 1320.

According to some embodiments of the present disclosure, if the path was switched during the call the call may be flagged for review 1325. This indicates that the system has detected a potential issue that needs further investigation. Otherwise, the QM application may continue monitoring 1330.

According to some embodiments of the present disclosure, the QM application may evaluate how the voice path switch impacted the overall quality of the call 1340. Switching paths could lead to issues, such as degraded audio quality, latency, or other disruptions in the customer-agent communication.

According to some embodiments of the present disclosure, the QM application may assess customer feedback (CSAT) based on call quality 1350, which reflects the customer's perception of the call's quality. If the voice quality is poor, CSAT might also be lower.

According to some embodiments of the present disclosure, the QM application may generate performance feedback for the agents based on the call quality and CSAT 1360. Regardless of whether the voice path was switched or not, the QM application may generate performance feedback for the agent based on measured call quality during the call and customer feedback (CSAT). The performance feedback is intended to help agents understand how they performed during the call and whether there are areas for improvement.

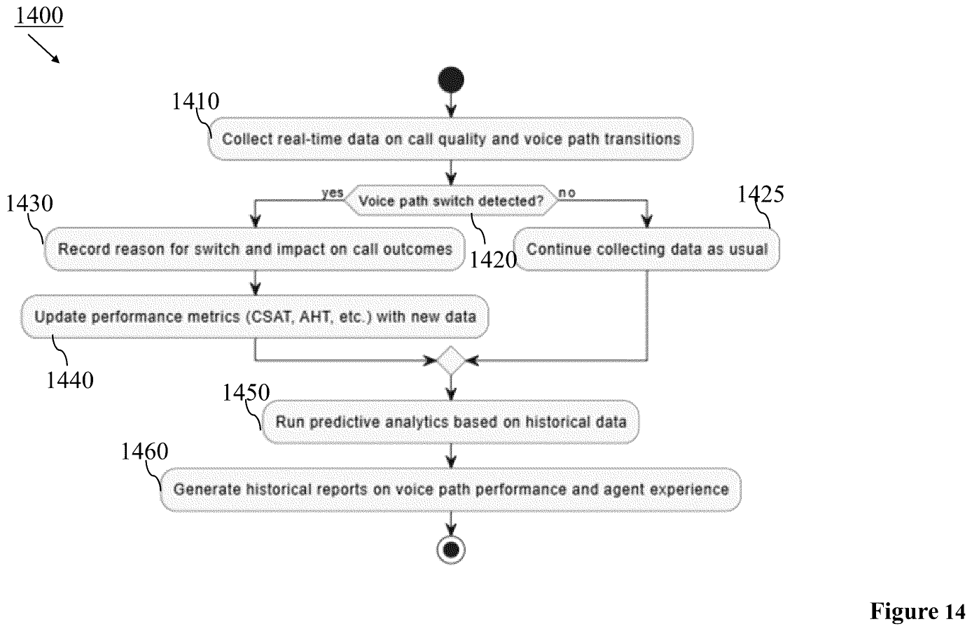

FIG. 14 schematically illustrates a high-level flowchart 1400 of impact of QoS on real-time analytics and reporting systems, in accordance with some embodiments of the present invention.

According to some embodiments of the present disclosure, a system, such as system 100 in FIG. 1, which automatically detects and switches to a “next-best” voice path, may impact real-time analytics and reporting systems.

According to some embodiments of the present disclosure, the dynamic voice channel selection system, which automatically detects and switches to a “next-best” voice path, can have a significant impact on several other call center systems, like real-time analytics and reporting systems.

According to some embodiments of the present disclosure, the dynamic voice channel selection system will provide a huge amount of data about call quality, transitions, and performance metrics.

According to some embodiments of the present disclosure, the impact on analytics and reporting systems includes new data points for analysis. Real-time reporting systems may incorporate new data points, such as the frequency of voice path switches, the reason behind the switch, and its effect on call outcomes. This data can help in analyzing broader trends and improving future voice channel configurations.

According to some embodiments of the present disclosure, the impact on analytics and reporting systems includes predictive analytics. The system's AI engine which is a learning module may generate predictive insights about potential future voice quality degradation based on historical data.

According to some embodiments of the present disclosure, the impact on analytics and reporting systems further includes historical reporting. Post-call analytics could also focus on how voice quality affects metrics like CSAT, AHT, and FCR, highlighting which voice paths yield the best outcomes. Reports could also focus on the agent's experience during poor-quality interactions, identifying which voice devices are more prone to issues.

According to some embodiments of the present disclosure, the real-time analytics and reporting systems may collect real-time data on quality and voice path transitions 1410. This could include parameters like call duration, jitter, latency, packet loss, and other key voice quality indicators. The data that may be collected is call quality metrics, such as MOS score, jitter and delay and such as voice path transitions, such as type of transition and timing.

According to some embodiments of the present disclosure, voice path transitions are also tracked by checking if voice path switch detected 1420. A switch may happen due to network fluctuations, resource availability, or network optimizations. A voice path transition could mean the switching of the call route, e.g., from a VoIP network to a PSTN or from one device to another during the call. These transitions are important for understanding potential impacts on call quality.

According to some embodiments of the present disclosure, when the voice path switch has been detected recording the reason for switch and impact on call outcomes 1430. If a switch is detected, the system records the reason behind the voice path switch. This could be due to network congestion, system maintenance, or routing optimizations.

According to some embodiments of the present disclosure, otherwise, collecting data as usual 1425. If no voice path switch is detected, the system continues to collect real-time data as usual. The system would keep tracking the standard call quality metrics, e.g., jitter, packet loss without the need to update performance metrics specifically for voice path transitions.

According to some embodiments of the present disclosure, the system also evaluates the impact of the switch on the call outcome, such as changes in call quality, e.g., worse audio quality after the switch.

According to some embodiments of the present disclosure, updating performance metrics, such as CSAT, AHT and the like with new data 1440 from the voice path switch and then running predictive analytics based on historical data 1450.

According to some embodiments of the present disclosure, after the real-time data collection and analysis of voice path transitions, the system may run predictive analytics which may include analyzing past call data e.g., historical data to predict future trends.

According to some embodiments of the present disclosure, predictive models can estimate potential issues, such as: whether a call is likely to suffer a voice path transition, if such a transition is likely to degrade call quality or impact customer experience, and predictive insights on how network conditions or system changes might affect call performance.

According to some embodiments of the present disclosure, the historical data provides context to understand patterns, such as whether specific voice path switches correlate with poor customer satisfaction or longer call handling times.

According to some embodiments of the present disclosure, generating historical reports on voice performance and agent experience 1460. Once predictive analytics is done, the system may generate historical reports that include insights into voice path performance and agent experience. The voice path performance may include statistics on how often voice path switches happen, their causes, and their impact on call quality. The agent's experience relates to the reports covering the agents' performance, such as how often agents deal with issues related to voice path transitions and how it affects their interactions with customers.

According to some embodiments of the present disclosure, these reports can be used by CCaaS administrator or management, to understand long-term trends and to make strategic decisions around network optimizations, agent training, or system improvements.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for dynamically selecting a voice communication channel from a plurality of voice communication channels during an interaction, in a contact center based on Quality of Service (QoS) measurements, said computerized-method comprising:
for each agent in the contact center that is logged-in to an agent application:
(i) receiving a first voice communication channel selected by the agent via a User Interface (UI) that is associated to the agent application,
wherein the first voice communication channel is selected from the plurality of voice communication channels,
(ii) establishing the interaction of the agent via the selected first voice communication channel;
(iii) continuously monitoring the QoS of the first voice communication channel during the interaction of the agent and measuring QoS until the measured QoS of the first voice communication channel is below a preconfigured quality-threshold;
(iv) detecting a second voice communication channel in the plurality of communication channels with a measured QoS higher than the first voice communication channel and other voice communication channels in the plurality of voice communication channels by operating a learning module;
(v) providing the second voice communication channel to the agent application; and
(vi) configuring the agent application to automatically select in real-time the second voice communication channel for the interaction.

2. The computerized-method of claim 1, wherein the voice communication channel is selected by the agent during log-in of the agent to the agent application.

3. The computerized-method of claim 1, wherein the learning module comprising:
(i) collecting QoS data of each voice communication channel in the plurality of voice communication channels in real-time during interactions throughout a preconfigured period;
(ii) analyzing the collected QoS data to yield an average measured QoS for each voice communication channel,
wherein the average measured QoS of each voice communication channel is time-based and season-based;
(iii) sorting the plurality of voice communications channels in descending order based on the average measured QoS;
(iv) determining the voice communication channel having highest measured QoS as the second voice communication channel.

4. The computerized-method of claim 3, wherein said QoS data comprising at least one metric of:
(i) Mean Opinion Score (MOS); (ii) packet loss percentage; (ii) jitter; and (iii) latency.

5. The computerized-method of claim 3, wherein said analyzing of the collected QoS data comprising:
(i) operating statistical analysis by computing averages, trends, and deviations to identify overall performance;
(ii) detecting patterns by applying Machine Learning (ML), time-series based analysis; and
(iii) detecting anomaly to predict when the QoS measurement will be below the preconfigured quality-threshold, based on the detected patterns.

6. The computerized-method of claim 1, wherein each voice communication channel in the plurality of voice communication channels comprising at least one of: (i) device ID; (ii) device type; (iii) device model; and (iv) device status.

7. The computerized-method of claim 1, wherein the providing of the second voice communication channel to the agent application comprising:
(i) receiving an alert to initiate failover;
(ii) initiating failover mechanism based on preconfigured failover policy; and
(iii) establishing the second voice communication channel by using a protocol that is
compatible to the preconfigured failover policy.

8. The computerized-method of claim 1, wherein the interaction that is established via the first voice communication channel is conducted via a related network path and using a first codec.

9. The computerized-method of claim 11, wherein when the measured QoS of the first voice communication channel is below a preconfigured quality-threshold, the computerized-method further comprising rerouting the interaction via a second network path, and
wherein said computerized-method further comprising operating a prediction module to determine the network path and a second codec for the second voice communication channel.

10. The computerized-method of claim 1, wherein the continuous monitoring of the QoS of the first voice communication channel during the interaction of the agent and the measuring of the measured QoS data is operated by a Voice Quality Monitoring (VQM) software.

11. A computerized-system for dynamically selecting a voice communication channel from a plurality of voice communication channels during an interaction, in a contact center based on Quality of Service (QoS) measurements, said computerized-system comprising:
a database;
a memory to store the database;
a User Interface (UI) that is associated to an agent application; and
one or more processors, said processors are configured to:
for each agent in the contact center that is logged-in to the agent application:
(i) receive a first voice communication channel selected by the agent via the UI that is associated to the agent application,
wherein the first voice communication channel is selected from the plurality of voice communication channels,
(ii) establish the interaction of the agent via the selected first voice communication channel;
(iii) continuously monitor the QoS of the first voice communication channel during the interaction of the agent and measure QoS until the measured QoS of the first voice communication channel is below a preconfigured quality-threshold,
wherein the measured QoS is stored in the database,
(iv) detect a second voice communication channel in the plurality of communication channels with a measured QoS higher than the first voice communication channel and other voice communication channels in the plurality of voice communication channels by operating a learning module;
(v) provide the second voice communication channel to the agent application; and
(vi) configure the agent application to automatically select in real-time the second voice communication channel for the interaction.
